(19) United States
(12) Patent Application Publication
(10) Pub. No.: US 2003/0045308 A1
(43) Pub. Date: Mar. 6, 2003

(54) Wireless data access infrastructure based upon an open platform

(76) Inventors: Ikhlaq Sidhu, Vernon Hills, IL (US); Tim Wilson, Rolling Meadows, IL (US); Karl Freter, Wheaton, IL (US); Guido Schuster, Zurich (CH)

Correspondence Address: Welsh & Katz, Ltd., Jon P. Christensen, 22nd Floor, 120 South Riverside Plaza, Chicago, IL, 60606, US

(21) Appl. No.: 09/945,486

(22) Filed: Aug. 30, 2001

(51) Int. Cl. H04Q 7/20

(52) U.S. Cl. 455/466; 455/414; 455/556; 455/566

(57) ABSTRACT

A method and apparatus are described for providing data services to a mobile data device through a packet data service node system and a wireless data network. The method includes the steps of exchanging data between the mobile data device and packet data service node system at least partially through the wireless data network using a tunneling protocol, decoding the tunneling protocol within a programmers space of a general purpose computing platform of the packet data service node system, determining an identity of the user from the decoded tunneling protocol and providing at least some data services to the identified user based upon a predetermined services list associated with the identified user.

### FIELD OF THE INVENTION

The invention relates to an apparatus for providing Internet data services that may be provided to mobile data devices through wireless data networks.

### BACKGROUND OF THE INVENTION

Mobile data devices (including cellular phones, Personal Data Assistants (PDAs) and mobile computers) are known. A screen is typically provided for the display of data.

Within the mobile data device, a windows-type operating system is often provided. A graphical users interface (GUI) may be provided to reduce the need for external control keys and keyboards.

When a mobile data device is activated, a menu screen is typically provided for selection, by a user, of a particular data feature. Once a particular feature is selected, the mobile data device may activate its internal transceiver and transmit a request for the feature to a cellular base station. The cellular base station may couple the request through a local Internet connection to the Internet destination. When a data response is received, the base station may couple the data response back to the mobile data device. In some cases, the menu of capabilities is itself part of the data response sent back to the mobile data device.

It can be difficult for service providers to offer Internet services to cellular based mobile data devices. There are a number of reasons for this difficulty. For example, the cellular telephone system and the Internet are fundamentally different environments. Protocols and hardware developed for one environment and not necessarily compatible with the other.

As data service is currently offered for mobile data devices, a user purchases the device and subscribes for service with a local wireless provider. When the device requests service, the local wireless provider tests whether the user has paid an access charge. If the access charge has been paid, the device is allowed access to the Internet.

In the past, carrier grade services have been offered using specialized hardware equipment for use by the service provider. Because of the inflexibility of the specialized hardware solutions, it has been difficult to modify the existing hardware platforms to offer wireless data services, including specialized user level services, menu options, new forms of user authorization an authentication, efficiency optimizations, and content based billing to the existing apparatus for providing carrier grade services.

### SUMMARY OF THE INVENTION

A method and apparatus are described for providing data services to a mobile data device through a packet data service node system and a wireless data network. The method includes the steps of exchanging data between the mobile data de-vice and packet data service node system at least partially through the wireless data network using a tunneling protocol, decoding the tunneling protocol within a programmers space of a general purpose computing platform of the packet data service node system, determining an identity of the user from the decoded tunneling protocol and providing at least some data services to the identified user based upon a predetermined services list associated with the identified user.

### BRIEF DESCRIPTION OF THE DRAWINGS

FIG. 1 is a block diagram of a packet data services network in accordance with an illustrated embodiment of the invention;

FIG. 2 is a block diagram of a programmers space of the system of FIG. 1;

FIG. 3 depicts a screen on a personal data assistant that may be provided by the system of FIG. 1;

FIG. 4 depicts a screen on a personal data assistant that may be provided by the system of FIG. 1;

FIG. 5 is a block diagram of a personal data assistant that may be used with the system of FIG. 1;

FIG. 6 is a block diagram of a radio node that may be used with the system of FIG. 1;

FIG. 7 depicts an IP packet that may be used by the system of FIG. 1;

FIG. 8 depicts an RN/PDSN data link packet that may be used by the system of FIG. 1; and

FIG. 9 depicts an tunneling packet that may be used by the system of FIG. 1.

### DETAILED DESCRIPTION OF A PREFERRED EMBODIMENT

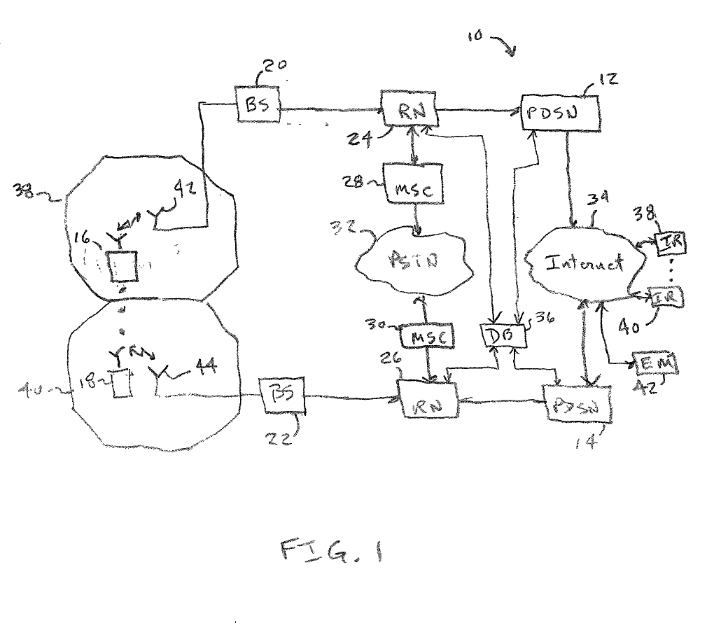

FIG. 1 depicts a packet data services node (PDSN) system 10 in a context of use and in accordance with an illustrated embodiment of the invention. As shown, a number of mobile data devices MDDs 16, 18 may travel through different geographic areas 38, 40 and receive data services through local antennas 42, 44 of the cellular network. As used herein, the acronym “MDDS” refers to conventional PDAs and also to any other wireless device that has the data access, retrieval and display capabilities of a conventional PDA (e.g., appropriately equipped cellular telephones or pagers, personal computers with wireless interfaces, etc.).

Further, while the PDSN system 10 will be described in terms of cellular services offered within the U.S., it is to be understood that the PDSN system 10 may also be implemented within the cellular systems of other countries (e.g., GSM in Europe, JTACS in Japan, etc.). For example, GGSN is an equivalent packet data services network used in conjunction with GSM. GTP is a GSM tunneling protocol supporting end-to-end processes similar to those described below. It is to be understood that the descriptive terms used herein are intended to include the corresponding processes and structure of the cellular systems of other countries.

To access data services within the U.S. cellular system, a MDD (e.g. 16) may activate on ON softkey 64 (FIG. 3) on a screen 50 of the MDD 16. In response, a central processing unit CPU 80 (FIG. 5) within the MDD 16 may activate the transceiver 84 and search for a control channel of a local base station (BS) 20.

Upon locating a control channel, the CPU 80 may compose an access request. The access request may be transferred to the transmitter 84 and be transmitted to the base station (BS) 20. The access request may include an identifier of the MDD 16 (e.g., a MIN number, IMSI number, etc.).

The BS 20 may respond with an acknowledgement including a randomly generated call identifier. The call identifier may be used by the MDD 16 and BS 20 as a pseudo-address to identify subsequent transmissions between the BS 20 and the MDD 16.

The BS 20 may also transfer the request to a local radio node (RN) 24. The RN 24 may recognize from the identifier of the MDD 16 that the access request is for data services and may transfer the request to an associated PDSN node 12.

In order to facilitate transfer of the access request to the PDSN 12, the RN 24 may set up a RN/PDSN data link between the RN 24 and PDSN node 12 based upon an appropriate protocol (e.g., Generic Routing Encapsulation (GRE)). GRE is a protocol which allows an arbitrary network protocol A to be transmitted over any other arbitrary network protocol B, by encapsulating the packets of A within GRE packets, which in turn are contained within packets of B. The use of GRE is described in RFC 1701 and RFC 1702 by the Internet Engineering Task Force (IETF) in the context of GRE over IP.

In addition to allowing the exchange of data between the RN 24 and PDSN node 12, the RN/PDSN data link may also support the use of tunneling protocols between the PDSN node 12 and MDDs 16, 18. The tunneling link provides a mechanism for transporting multi-protocols datagrams between the PDSN and MDD.

As used herein, the packets of protocol A processed for transmission over the RN/PDSN data link may be supplied under the tunneling protocol (e.g., a Point to Point Protocol (PPP)) established by the PDSN node 12 with the MDD 16 through the RN 24. The packets of B may be IP. The format of PPP encapsulated in GRE, encapsulated in IP is referred to as a PPP over GRE over IP protocol.

PPP includes at least three components: 1) a method of encapsulating datagrams; 2) a link control protocol (LCP) for establishing, configuring and testing the data-link connection and 3) a family of network control protocols (NCPs) for establishing and configuring different network-layer protocols. PPP is described in RFC 1661.

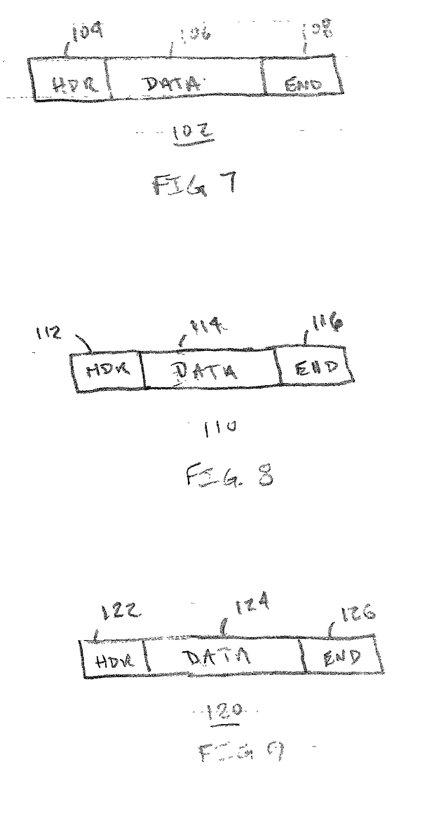

To form the RN/PDSN data link, the RN 24 may transmit a setup instruction from a data link code plug of the RN 24 to a corresponding data link code plug of the PDSN 12. For purposes of explanation, a data link CODEC application 96 of the RN 24 and a data link CODEC application 154 of the PDSN 12 may be regarded as the corresponding set of data link code plugs. The data link CODECS 96, 154 may be used both for setup of the RN/PDSN data link and also for decoding RN/PDSN data link packets 110 (FIG. 8).

To set up the RN/PDSN data link, the data link CODEC 96 may retrieve a default address 101 of the corresponding data link CODEC 154 from a memory 100 of the RN 24. Upon retrieving an address, the data link CODEC 96 may compose a setup request and send it to the PDSN 12.

Within the PDSN 12, a router 158 may decode a header of the setup request, recover the address 101 of the data link CODEC application 154, and route the setup request to the data link CODEC application 154. Within the data link CODEC application 154, the setup request may be decoded and send to a processing application (e.g., application #1 162).

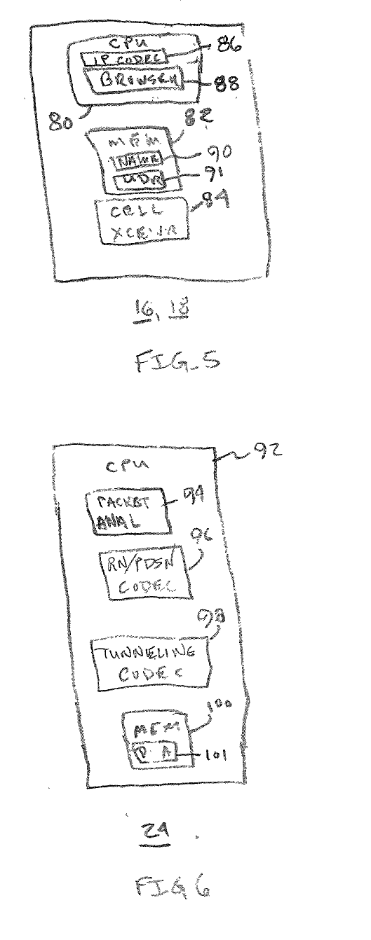

The application 162 may, in turn, activate a tunneling CODEC application 156. As with the RN/PDSN data link, the tunneling CODEC 156 of the PDSN 12 may represent a first tunneling code plug and the tunneling CODEC 98 of the RN 24 (FIG. 6) may represent a corresponding second tunneling code plug.

Upon activation of the corresponding sets of data link code plugs and tunneling code plugs, a RN/PDSN data link may be set up between the RN 24 and PDSN 12. Similarly, a tunneling link may be set up between the PDSN 12 and MDD 16.

In general, the data and tunneling links provide communication channels that are transparent to the respective devices. The tunneling link may be used by the PDSN 14 to receive communications requests from the MDD 16 and to download data to the MDD 16. The RN/PDSN data link may be used to support of the tunneling link and also to exchange control and billing information between the RN 24 and PDSN 12.

As discussed in more detail below, the application 162 may function through the data and tunneling links to provide authentification/authorization (AA) features directed to identification of the MDD 16. The application 162 may also provide data services to the MDD 16 under control of a user profile (e.g., UP #1 168). In effect, the application 162 may provide user services to the user of the MDD 16 based upon the services selected and subscribed to by the user. To provide the selected services, the application 162 may function as a buffer between the MDD 16 and the Internet 34.

By placing the application 162 within the PDSN 12, instead of within the MDD 16, data traffic across the wireless interface may be reduced. Further, by placing the application 162 within the system 10 (instead of within the MDD 16), data services provided to the MDD 16 may be specifically tailored to the user. Further, billing entries for optional or incremental services may be made based upon the-user's identify and upon use.

In general, the system 10 may be implemented within a programmers space of a general purpose computing platform 12, 14. Implementing the system 10 within the programmers space allows applications 150, 152, 154, 156, 158, 162, 164, 166 to share information.

For example, by performing the coding and decoding of RN/PDSN data link packets and tunneling protocol packets within the programmers space, an identity of a user may be determined and passed among applications. The determination of the identity of a user has not been possible under the prior art because coding and decoding have been performed in dedicated processors that were not connected or structured to provide information to external applications.

By knowing the identity of a user, subscriber information may be retrieved from files 168, 170. By knowing the identity of the user of the MDD 16, the data services may be customized to the user and billed accordingly.

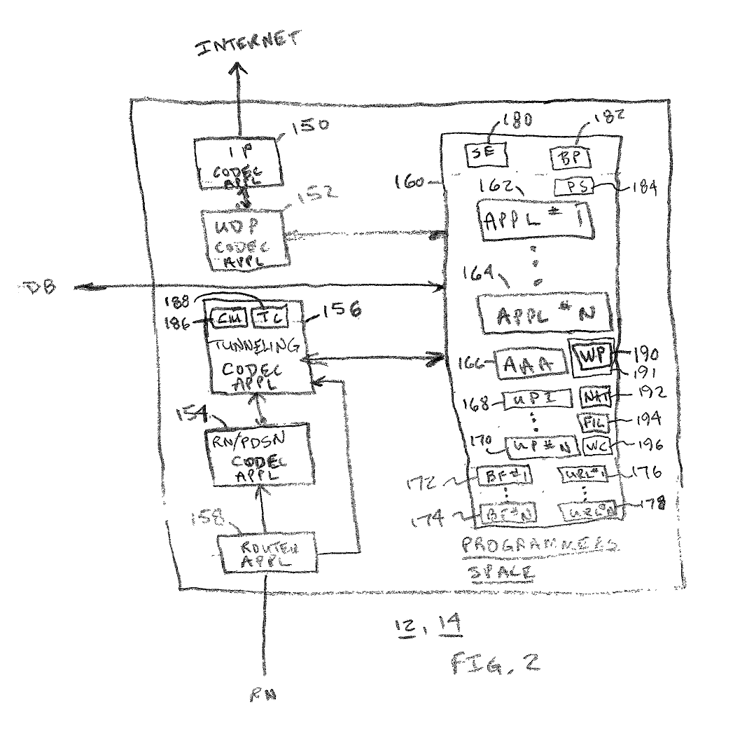

The relegation of tunneling, identification, billing and resource allocation functions to the programmers space shown in FIG. 2 offers a number of other advantages. Other than the fact that it is cheaper, it is also more flexible in terms of customization to the needs of local, national or international users. Where it is determined that the needs of a particular segment of users are not being served properly, the commonality of resources allows the needs of those users to be quickly and efficiently addressed.

Since the functionality of the PDSN system 10 is located within a common environment, the content of the programmers space may be easily recompiled as the operating environment of a system changes. The ability to easily and quickly recompile the content of the programmers space allows for greater portability across multiple operating systems. Further, since the input/output exist under a common format, the content of the programmers space is easily adapted among multiple hardware platforms and specialized I/O interfaces.

Turning now to the specifics of the system 10, a description will be provided of the processes used in providing data services. Following a description of the processes, a number of examples will be provided of specific data services.

In the example discussed above, once the access request is received from the MDD 16, the application 162 may first set up a tunneling link directly between the MDD 16 and the application 162. In effect, the application may set up a PPP over GRE over IP connection directly with the MDD 16 using the information provided by a receiving RN 24, 26.

Following setup of the tunneling link with the MDD 16, the application 162 may transfer a challenge that may be forwarded to the MDD 16. Using well-known techniques, the MDD 16 may encrypt the challenge using its own internal identifier and return the encrypted response to the application 162. The original challenge and encrypted challenge may be forwarded to a database 36 (e.g., a Radius database by Funk) that decrypts the encrypted challenge using its own knowledge of the authorized user's internal identifier. If the challenge decrypted by the database 36 matches the original challenge, the database 36 transfers an identifier of the authorized user to the application 162. The application 162, in turn, may transfer an access grant to the MDD 16.

Once the MDD 16 has been granted access, the CPU 80 of the MDD 16 may compose and forward a data request. The data request may include an indicator of the type of request.

To encode the data request for transmission across the wireless interface, the CPU 80 may send the request to an Internet Protocol (IP) coder/decoder (CODEC) 86. The IP CODEC 86 may encode the request as an IP packet 102 (FIG. 7).

As shown in FIG. 7, an IP packet 102 may include a header 104, data 106 and an end 108. The type of request, user name and system identifier may be included within the data section 106. The header of the IP packet 102 may be a packet destination. In this case, the address used for the header 104 may be the user datagram protocol (UDP) of a user service application 162, 164 within the PDSN 12. The end section 108 may include any of a number of possible end bits (e.g., parity coding, CRC, etc.).

Once the CODEC 86 has encoded the IP packet 102, the IP CODEC may transfer the IP packet 102 to the transceiver 84. The transceiver 84 may transmit the IP packet to the BS 20 through the antenna 42. The BS 20 may, in turn, forward the IP packet 102 to the RN 24.

Within the RN 24, 26, the IP packet 102 may be encoded within the data link CODEC 96 into a RN/PDSN data link packet 110 (FIG. 8). A header 112 of the RN/PDSN data link packet 110 may include an address of the corresponding data link CODEC 154 of the PDSN 12, 14. The data section 114 may include the IP packet 102.

The data link packet 110 in turn may be encoded as a tunneling packet 120. As above, a header 122 of the tunneling packet 120 may include an address of the corresponding tunneling CODEC 156 of the PDSN 12, 14. The data section 114 may include the data link packet 110.

At the same time that the application returns the access grant to the authorized user, the application 162 may access a user profile 168 of the authorized user to determine the specific data services paid for by the authorized user. Depending upon the service level subscribed to by the user and the user's selections, the application 162 may transparently pass packets between the MDD 16 and the Internet 34 or function as a proxy for the MDD 16.

Using the user profile 168, customized services may be offered to subscribers at a number of different service levels. Further, specialized services may be bundled to tailor offered services precisely to the user's need.

For example, when a MDD 16, 18 first signs on, the PDSN 12, 14 may download a menu 50 (FIG. 3) of options. The options shown may be limited to those options which the user subscribes to or may include both subscribed and unsubscribed options.

Further, the user profile 168, 170 may be a set of pointers to subroutines that provide the services paid for by the user. In this case, the application 162 may simply be a shell program that tracks user input, performs network address translation (NAT) to provide the user input to the appropriate subroutine and couples requested information to the user.

For example, if the user has paid for such services, the user may activate a STOCKS softkey 52 and receive current market quotations. Where the STOCKS key 52 is activated, the application 162 may detect the activation of such key 52 and retrieve a universal resource locator (URL) 176, 178 of an information resource 38, 40 (i.e., a web site) providing such information. Upon retrieving such information, the application 162 may download the information to the MDD 16, 18.

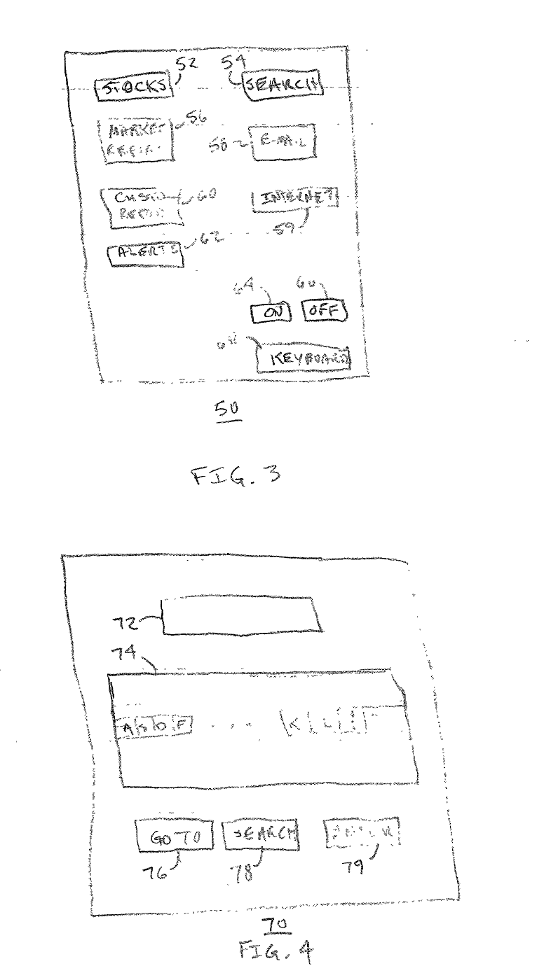

Alternatively, the user may activate a SEARCH key 54. In this case, the application 162 may retrieve a URL 176, 178 of its own search engine 180, either within the PDSN 12, 14 or at some other predetermined location on the Internet. Where the application 162 takes the user to its own search engine, the web page 70 (FIG. 4) may be provided to the user on the user's MDD 16, 18 for entry of search terms. The user may enter search terms appearing in a window 72 using a keyboard 74.

To protect the application 162 (and/or the search engine 180), inquiries directed to external servers through the Internet may be directed through a web proxy server 190 operating from within a firewall 191. The proxy server 190 may protect internal clients by performing network address translation. The proxy server 190 may listen for requests from clients on the protected side of the firewall 191 and forward these requests to remote Internet servers outside the firewall using its own address as a return address. When a response is received, the proxy server 190 reads the response from the external servers, matches it with the original request and then sends it to the internal client.

Further, the web proxy 190 may function to store frequently accessed documents in a web cache 196. An entire workgroup of applications 162, 164 may be configured to use the cache of documents 196. This reduces loading on the proxy server 190 by allowing the applications 162, 164 to retrieve documents from the cache 196 for retransmission to MDDs when responding to subsequent requests.

Parental controls may also be implemented within the application 162, 164 or within the web proxy 190. In either case, a set of filters 194 may be provided identifying various levels of parental control based upon web site content. The level of parental control may be determined from the user profile 168 retrieved by the application 162, 164 during the initial connection. The appropriate filter from the set of filters 194 may be used to accept or deny web access requests based upon filter content.

The firewall 191 may also examine and filter incoming packets based upon a predetermined criteria. The predetermined criteria may be based upon a pattern of attack signature or upon some other criteria (e.g., packets directed to protected applications or data within the programmers space). When a packet is identified as meeting the predetermined criteria, the packet may be deleted.

Because of the small size of the screen on the MDD 16, 18, the application 162 may also function as filter for content translation. For example, commercial search engines typically download advertisements along with presented materials. The application 162 may detect and delete html information associated with such advertisements.

The application (e.g., application 162) may also perform image conversion to adapt images to the screen size of the MDD 16, 18. Techniques such as down/up sampling and format translation may be used to enhance image clarity while minimizing the data volume passing through the wireless interface. What data does pass through the wireless interface may be compressed to further enhance performance while reducing channel loading.

Further, the application 162 may note and save information sufficient to provide a basis for charging the user for each search performed during a billing period. For example, as each search is performed, a billing processor 182 associated with the application 162 may store the search terms and date and time in a billing file 172, 174. At the end of the billing period, the user may be invoiced for each search or for searches above some threshold level.

Alternatively, if the user has paid for such services, then the user may access the Internet through the proxy server 190, or directly, either by activation of the INTERNET key 59 or by activating the KEYBOARD key 68. In either case, the keyboard 70 (FIG. 4) may be downloaded to the MDD 16, 18. The user may enter a search term (or website) displayed in a window 72 by using the keyboard 74.

In either case, the browser may be located in the application 162, instead of the MDD 16. Locating the browser in the application 162 reduces the intelligence necessary within the MDD 16. Locating the browser in the application 162 further reduces the data volume across the wireless interface and allows the MDD 16 to function simply as a graphical user interface.

In a similar manner, the user may activate an E-MAIL key 58. In response, the application 162 may retrieve a URL 176, 178 of the user's e-mail server 42. Upon accessing the server 42, the application 162 may receive and download a summary of the user's e-mail file. Once the user's file has been accessed, individual e-mails may be retrieved and read using methods well known in the art. As the user downloads each e-mail, the billing file 172, 174 may be updated accordingly by a billing processor 182.

The processing of data requests within the programmers space allows great flexibility in the processing and tracking of access requests. The ability to redirect http and wireless application protocol (WAP) requests to specialized search engines 180 allows the billing processor 182 to analyze and measure the content and scope of each access request. The ability to measure the scope and content of access requests provides a significant advantage in terms of the ability to relate use to cost.

In addition to the multitude of services that become available, the PDSN system 10 also provides a significant increase in data transfer efficiency between Internet resources and the MDD. For example, the PSDN system 10 has the ability to channel code the TCP protocol to maximize throughput from an information theory point of view and from a networking point of view.

As mentioned above, cellular telephone system and the Internet are fundamentally different environments. The wireless path between the base station and the cellular receiver is subject to any number of different data transfer obstacles (e.g., random interference, multipath interference, signal fading, signal blocking, etc.). In order to improve the reliability of the radio link, the data is, in most cases, transferred slower and in smaller increments.

Further, the loss of small amounts of voice data is not critical to understanding a conversation. As a result, error correction and detection are not usually necessary over the wireless link.

In contrast, data transferred through the Internet is transferred at a relatively high rate of speed in relatively large blocks. Once a block is transferred, the sender may wait for an acknowledgement.

When the data transfer characteristics of the Internet are applied to MDDs, the result is less than satisfactory. When a large block of data is transferred, the loss of only a small part of the block requires the retransmission of the entire block. Further, in the case of a web site transmission, the acknowledgement of receipt of a block must pass from the MDD all the way to the website before the next block may be transferred.

To reduce the difficulties associated with transmission of information to the MDD 16, 18, the PDSN system 10 may reformat information passing between the two systems. A transcoder 188 and cache memory 186 may be provided within the TUNNELING CODEC 156 to locally store large blocks (web pages) or small blocks (e.g., TCP packets) received from the Internet side of the tunneling CODEC 156. The transcoder 188 may function to return acknowledgements to the sender for information traveling in either direction.

The caching of packets in cache memory 186 within the PDSN 10 allows the transcoder 188 to break up large packets into small packets for transmission across the wireless interface. Where a packet is lost, it may be recovered from the local cache 186, thereby reducing time and eliminating the need to retransmit a large block of information from a remote web site.

Further, the transcoder 186 may also provide error correction and control from within the tunneling CODEC 156. Such error correction and control may be implemented under any of a number of different formats (e.g., parity, CRC, etc.). Since correction and control is accomplished from within the PDSN system 10, the traffic associated with such correction and control is localized to the area between the MDD and PDSN 10.

The transcoder 186 also allows for the use of flow control within the system 10. As large packets are received, the transcoder 186 may defer returning an acknowledgement until the large packet has been processed into small packets and the MDD has acknowledged receipt of each of the small packets. Flow control may be used to reduce a size of the cache memory 186 within the PDSN 10.

The transcoder 186 may also automatically adjust retransmit times to the specifics of the associated cellular system. Since cellular systems are inherently slower than the Internet, the automatic adjustment of retransmit times substantially reduces the need for unnecessary retransmissions, thereby further reducing unnecessary traffic.

A specific embodiment of a method and apparatus for providing a wireless data access infrastructure based upon an open architecture has been described for the purpose of illustrating the manner in which the invention is made and used. It should be understood that the implementation of other variations and modifications of the invention and its various aspects will be apparent to one skilled in the art, and that the invention is not limited by the specific embodiments described. Therefore, it is contemplated to cover the present invention and any and all modifications, variations, or equivalents that fall within the true spirit and scope of the basic underlying principles disclosed and claimed herein.

1. A method of providing data services to a mobile data device through a packet data service node system and a wireless data network, such method comprising the steps of:
exchanging data between the mobile data device and packet data service node system at least partially through the wireless data network using a tunneling protocol;
decoding the tunneling protocol within a programmers space of a general purpose computing platform of the packet data service node system;
determining an identity of the user from the decoded tunneling protocol; and
providing at least some data services to the identified user based upon a predetermined services list associated with the identified user.

2. The method of providing data services as in claim 1 further comprising retrieving a predetermined description of data services subscribed to by the identified user.

3. The method of providing data services as in claim 2 further comprising coupling data packets received from the mobile data device to a proxy application.

4. The method of providing data services as in claim 3 further comprising defining a set of characteristics of the proxy application from the predetermined description of data services.

5. The method of providing data services as in claim 4 further comprising downloading a services menu from the proxy application to the mobile data device.

6. The method of providing data services as in claim 5 further comprising opening a billing file within the proxy application to track services actually provided to the user.

7. The method of providing data services as in claim 6 further comprising providing an e-mail selection option on the downloaded services menu.

8. The method of providing data services as in claim 7 further comprising downloading e-mail directed to the user upon selection by the user of the e-mail selection option.

9. The method of providing data services as in claim 8 further comprising incrementing the billing file for each downloaded e-mail.

10. The method of providing data services as in claim 6 further comprising providing a search selection option on the downloaded services menu.

11. The method of providing data services as in claim 10 further comprising uploading a search descriptor from the user upon selection by the user of the search option.

12. The method of providing data services as in claim 11 further comprising transferring the search descriptor from the user to a predetermined search engine based upon the predetermined description of services.

13. The method of providing data services as in claim 11 further comprising incrementing the billing file for each uploaded search descriptor.

14. The method of providing data services as in claim 11 further comprising deleting at least some html data downloaded to the mobile data device.

15. The method of providing data services as in claim 11 further comprising defining the deleted html data downloaded to the mobile data device as advertising information.

16. The method of providing data services as in claim 1 wherein the step of exchanging data further comprises transcoding the exchanged data between a point to point protocol over Generic Routing Encapsulation over Internet Protocol and a Generic Routing Encapsulation over Internet Protocol within a user space of the packet data service node system.

17. The method of providing data services as in claim 16 wherein the step of transcoding further comprises transferring the point-to-Point Protocol over Generic Routing Encapsulation over Internet Protocol and Generic Routing Encapsulation over Internet Protocol to a point to point protocol conversion application.

18. The method of providing data services as in claim 17 further comprising transcoding between the Generic Routing Encapsulation over Internet Protocol and Internet Protocol within the user space.

19. The method of providing data services as in claim 18 wherein the step of transcoding between the Generic Routing Encapsulation over Internet Protocol and Internet Protocol further comprises transferring the Generic Routing Encapsulation over Internet Protocol and Internet Protocol to a Generic Routing Encapsulation conversion application.

20. A method of servicing a mobile data device through a wireless data network, such method comprising the steps of:
exchanging data between the mobile data device and packet data service node system using a point to point Protocol over Generic Routing Encapsulation over Internet Protocol; and
transcoding the exchanged data between the point to point Protocol over Generic Routing Encapsulation over Internet Protocol and a Generic Routing Encapsulation over Internet Protocol within a user space of the packet data service node system.

21. The method of servicing a mobile data device through a wireless data network as in claim 20 wherein the step of transcoding further comprising transferring the point to point protocol over Generic Routing Encapsulation over Internet Protocol and Generic Routing Encapsulation over Internet Protocol to a point to point protocol conversion application.

22. The method of servicing a mobile data device through a wireless data network as in claim 21 further comprising transcoding between the Generic Routing Encapsulation over Internet Protocol and Internet Protocol within the user space.

23. The method of servicing a mobile data device through a wireless data network as in claim 22 wherein the step of transcoding between the Generic Routing Encapsulation over Internet Protocol and Internet Protocol further comprises transferring the Generic Routing Encapsulation over Internet Protocol and Internet Protocol to a Generic Routing Encapsulation conversion application.

24. The method of servicing a mobile data device through a wireless data network as in claim 1 further comprising caching packets received from a source web site for retransmission to the mobile data device.

25. The method of servicing a mobile data device through a wireless data network as in claim 1 wherein the step of caching packets further comprises caching TCP packets.

26. The method of servicing a mobile data device through a wireless data network as in claim 25 wherein the step of caching packets further comprises caching web pages.

27. The method of servicing a mobile data device through a wireless data network as in claim 1 further comprising transcoding packets within the programmers space.

28. The method of servicing a mobile data device through a wireless data network as in claim 1 further comprising reformatting images within the programmers space.

29. The method of servicing a mobile data device through a wireless data network as in claim 1 further comprising filtering data requests for parental control.

30. The method of servicing a mobile data device through a wireless data network as in claim 1 further comprising filtering packets received through an Internet connection for firewall protection.

31. The method of servicing a mobile data device through a wireless data network as in claim 30 further comprising deleting packets received through an Internet connection meeting a predetermined pattern of attack criteria.

32. The method of servicing a mobile data device through a wireless data network as in claim 1 further comprising performing network address translation.

33. An apparatus for providing data services to a mobile data device through a packet data service node system and a wireless data network, such apparatus comprising:
means for exchanging data between the mobile data device and packet data service node system at least partially through the wireless data network using a tunneling protocol;
means for decoding the tunneling protocol within a programmers space of the packet data service node system;
means for determining an identity of the user from the decoded tunneling protocol; and
means for providing at least some data services to the identified user based upon a predetermined services list associated with the identified user.

34. The apparatus for providing data services as in claim 33 further comprising means for retrieving a predetermined description of data services subscribed to by the identified user.

35. The apparatus for providing data services as in claim 33 further comprising means for coupling data packets received from the mobile data device to a proxy application.

36. The apparatus for providing data services as in claim 35 further comprising means for defining a set of characteristics of the proxy application from the predetermined description of data services.

37. The apparatus for providing data services as in claim 36 further comprising means for downloading a services menu from the proxy application to the mobile data device.

38. The apparatus for providing data services as in claim 37 further comprising means for opening a billing file within the proxy application to track services actually provided to the user.

39. The apparatus for providing data services as in claim 38 further comprising means for providing an e-mail selection option on the downloaded services menu.

40. The apparatus for providing data services as in claim 39 further comprising means for downloading e-mail directed to the user upon selection by the user of the e-mail selection option.

41. The apparatus for providing data services as in claim 40 further comprising means for incrementing the billing file f or each downloaded e-mail.

42. The method of providing data services as in claim 38 further comprising means for providing a search selection option on the downloaded services menu.

43. The apparatus for providing data services as in claim 42 further comprising means for uploading a search descriptor from the user upon selection by the user of the search option.

44. The apparatus for providing data services as in claim 43 further comprising means for transferring the search descriptor from the user to a predetermined search engine based upon the predetermined description of services.

45. The apparatus for providing data services as in claim 43 further comprising means for incrementing the billing file for each uploaded search descriptor.

46. The apparatus for providing data services as in claim 43 further comprising means for deleting at least some html data downloaded to the mobile data device.

47. The apparatus for providing data services as in claim 43 further comprising means for defining the deleted html data downloaded to the mobile data device as advertising information.

48. The apparatus for providing data services as in claim 33 wherein the means for exchanging data further comprises means for transcoding the exchanged data between a point to point protocol over Generic Routing Encapsulation over Internet Protocol and a Generic Routing Encapsulation over Internet Protocol within a user space of the packet data service node system.

49. The apparatus for providing data services as in claim 48 wherein the means for transcoding further comprises means for transferring the point-to-Point Protocol over Generic Routing Encapsulation over Internet Protocol and Generic Routing Encapsulation over Internet Protocol to a point to point protocol conversion application.

50. The apparatus for providing data services as in claim 49 further comprising means for transcoding between the Generic Routing Encapsulation over Internet Protocol and Internet Protocol within the user space.

51. The apparatus for providing data services as in claim 50 wherein the means for transcoding between the Generic Routing Encapsulation over Internet Protocol and Internet Protocol further comprises means for transferring the Generic Routing Encapsulation over Internet Protocol and Internet Protocol to a Generic Routing Encapsulation conversion application.

52. An apparatus for providing data services to a mobile data device through a packet data service node system and a wireless data network, such apparatus comprising:
a wireless data network adapted to exchange data between the mobile data device and the packet data service node system using a tunneling protocol;
a tunneling CODEC adapted to decode the tunneling protocol within a programmers space of the packet data service node system;
an authentication application adapted to determine an identity of the user from the decoded tunneling protocol; and
a user application adapted to provide at least some data services to the identified user based upon a predetermined services list associated with the identified user.

53. The apparatus for providing data services as in claim 52 further comprising a data services file adapted to provide a predetermined description of data services subscribed to by the identified user.

54. The apparatus for providing data services as in claim 52 further comprising a proxy application adapted to coupling data packets between the mobile data device and a data source.

55. The apparatus for providing data services as in claim 54 further comprising a services menu adapted to be downloaded from the proxy application to the mobile data device.

56. The apparatus for providing data services as in claim 55 further comprising a billing file within the proxy application to track services actually provided to the user.

57. The apparatus for providing data services as in claim 56 further comprising an e-mail selection option on the downloaded services menu.

58. The apparatus for providing data services as in claim 55 further comprising means for providing a search selection option on the downloaded services menu. search descriptor.

59. The apparatus for providing data services as in claim 58 wherein the wireless data network further comprises a tunneling CODEC adapted to transcode the exchanged data between a point to point protocol over Generic Routing Encapsulation over Internet Protocol and a Generic Routing Encapsulation over Internet Protocol within a user space of the packet data service node system.

60. The apparatus for providing data services as in claim 59 further comprising a data link CODEC adapted to transcode between the Generic Routing Encapsulation over Internet Protocol and Internet Protocol within the user space.
